(19) United States
(12) Patent Application Publication
(10) Pub. No.: US 2006/0006573 A1
(43) Pub. Date: Jan. 12, 2006

(54) Protective hand covering and method of manufacture thereof

(75) Inventor: Kevin McNamara, Taichung (TW)

Correspondence Address: DIMOCK STRATTON LLP, 20 QUEEN STREET WEST SUITE 3202, BOX 102, TORONTO, ON, M5H 3R3, CA

(73) Assignee: R.O.C. Company Inc., Oakville (CA)

(21) Appl. No.: 11/108,806

(22) Filed: Apr. 19, 2005

Related U.S. Application Data
(63) Continuation of application No. 10/152,825, filed on May 23, 2002, now abandoned.

(30) Foreign Application Priority Data
Jan. 7, 2002 (CA) 2,366,654

(51) Int. Cl. B29C 43/02

(52) U.S. Cl. 264/132; 264/319

(57) ABSTRACT

A method of applying a slip-resistant surface to a hand covering, for example a glove, in a mold, comprising the steps of: a. placing a swatch of a host material in the mold, b. applying a slip-resistant material to the mold, c. applying heat and pressure to the slip-resistant material thereby bonding the slip-resistant material to the host material to produce a composite material, and d. constructing a hand covering using at least the swatch of composite material. The method may also include the step of cutting the swatch of composite material into a desired shape either before or after molding. The hand covering is constructed using the swatch of composite material and a second material, which may be the host material, the composite material or any other material. The slip-resistant surfaces may comprise a texture, and the hand covering may comprise a plurality of slip-resistant surfaces. Indicia and/or any other type of design can be applied to the host material prior to the application of a clear slip-resistant surface. The invention also includes a hand covering produced according to the method, for example a glove or mitten.

### FIELD OF THE INVENTION

This invention relates to protective hand coverings. In particular, this invention relates to a method of manufacturing a glove or mitten having one or more gripping surfaces provided with a slip-resistant material.

### BACKGROUND OF THE INVENTION

Protective hand coverings, for example gloves and mittens, have many functions. Amongst these are to protect the hands from the elements, such as cold or heat, and to protect the hands against injury.

A major disadvantage to such hand coverings is that, in most cases, feeling and grip are greatly diminished due to the materials used in their construction. The greater the protection afforded by the hand covering, the greater is the reduction in feeling and grip. A leather, fabric or nylon palm will not supply a sure grip when in contact with another surface. Thus, in many cases it is desirable to affix a slip-resistant material to the palm, and/or other surfaces of a hand covering, to enhance the user's grip.

Conventionally a separate slip-resistant patch, such as rubber, is cemented or stitched to the host material. However, because of the harsh conditions under which such protective coverings are used, particularly in industrial applications, the separate patch will almost invariably peel or move, no matter how securely sewn or cemented to the host material. Repeated use of the hand covering results in the host material moving in one direction and the patch in another, and/or the rubber actually stretching under the forces imparted during use.

It is also known to dip a finished and sewn glove or mitten into a slip-resistant material in the liquid phase, for example liquid rubber, and then remove it and cure the rubber. However, this process does not allow for control over the application of the slip-resistant material, and results an inconsistent thickness of the rubber. Also, in this process it is not possible to apply designs of textures to the rubber, which both improve its slip-resistance and provide a more aesthetically appealing look to the glove or mitten.

### SUMMARY OF THE INVENTION

The present invention provides a method of creating a slip-resistant surface over one or more surfaces of a hand covering which, when in contact with another surface, will provide the user with a better grip. The method of the invention allows for complete control over the thickness and texture of the slip-resistant surface, and ensures strong adhesion between the slip-resistant surface and the host glove or mitten material, for improved durability.

The invention accomplishes this by providing, during the construction of a glove or mitten, a slip-resistant surface which composed of a flexible, slip-resistant material, such as rubber, silicone rubber, PVC, TPR, or any other suitable material. The slip-resistant surface is applied by a molding process, for example injection molding, directly into the material used in the manufacturing of the glove or mitten. In the preferred embodiment the slip-resistant surface is applied to a swatch of the host material before the host material is cut for sewing into a hand covering.

According to the invention, the host material to be used in the production of the glove or mitten is placed into a mold. The mold can be designed to produce any desired texture on the slip-resistant surface, and any desired thickness of slip-resistant surface. The host material is placed in the mold together with a suitable slip-resistant material, for example raw rubber, which is then heated and compressed. The rubber intrudes into the pores of the host material and the slip-resistant surface is thus permanently bonded to the host material. The slip-resistant surface side of the mold can be designed to produce any desired texture in the slip-resistant surface.

After the application of heat and pressure the host material and slip-resistant material form a composite material, which is then removed from the mold and die cut or trimmed to the desired specifications to be sewn into a glove or mitten, for example using the composite material for the slip-resistant portions of the hand covering and the host material (or any other suitable material) for the remainder of the hand covering.

In a slip-resistant surface constructed according to the invention, the slip-resistant material is bonded directly into the pores of the host material. The slip-resistant surface will therefore not peel away from or shift relative to the host material. Moreover, by bonding the slip-resistant material to the host material in this fashion, the slip-resistant surface cannot stretch any more than the host material will allow.

The present invention thus provides a method of applying a slip-resistant surface to a hand covering in a mold, comprising the steps of: a. placing a swatch of a host material in the mold, b. applying a slip-resistant material to the mold, c. applying heat and pressure to the slip-resistant material thereby bonding the slip-resistant material to the host material to produce a composite material, and d. constructing a hand covering using at least the swatch of composite material.

In further aspects of the invention: the method includes, before step d., the step of cutting the swatch of composite material into a desired shape; the swatch of host material is cut to a desired shape before being placed in the mold; the hand covering is constructed using the swatch of composite material and second material; the second material is the host material; the composite material comprises a plurality of slip-resistant surfaces; the composite material comprises a plurality of slip-resistant surfaces interposed with surfaces of the host material disposed in positions corresponding to joints of a user's hand; the slip-resistant surface comprises a texture; and/or the method comprises, before step a. or step b., applying a design to the host material. The invention further comprises a hand covering produced according to the method, for example a glove.

### BRIEF DESCRIPTION OF THE DRAWINGS

In drawings which illustrate by way of example only a preferred embodiment of the invention,

FIGS. 1A to 1C are schematic views showing the method of the invention.

FIG. 2 ia a perspective view of a mold for the method of the invention.

FIG. 3 is a plan view of a slip-resistant surface of a glove having a print or screen applied to the host material.

FIG. 4 is a plan view of a slip-resistant surface of a glove having a plurality of slip-resistant surfaces molded onto a single piece of host material.

FIG. 5 is a plan view of a glove having a single slip-resistant surface molded over the entire portion of the host material corresponding to the gripping portion of a user's hand.

### DETAILED DESCRIPTION OF THE INVENTION

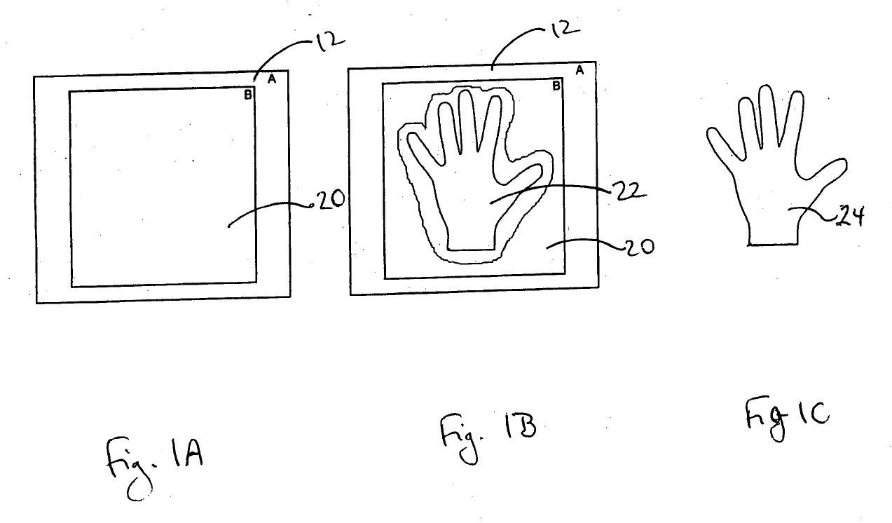

FIGS. 1A to 1C show a preferred embodiment of the method of the invention, in the example shown applying a slip-resistant surface to the palm of a glove. It will be appreciated that the invention can be implemented in any type of protective hand covering, including gloves and mittens, and although the invention will be described below in the context of a protective glove, the invention is not limited in this regard. Typically the slip-resistant surface would be applied to the front surface of a glove or mitten, and the invention is so described by way of example, however the invention is not limited to this exemplary embodiment and a similar surface can be applied to any portion of the hand covering for purposes of slip-resistance and/or protection.

In general, the method of the invention comprises the steps of placing a swatch of a host material in the mold; applying a slip-resistant material to the mold; applying heat and pressure to the slip-resistant material thereby bonding the slip-resistant material to the host material to produce a composite material; and constructing a hand covering using at least the swatch of composite material.

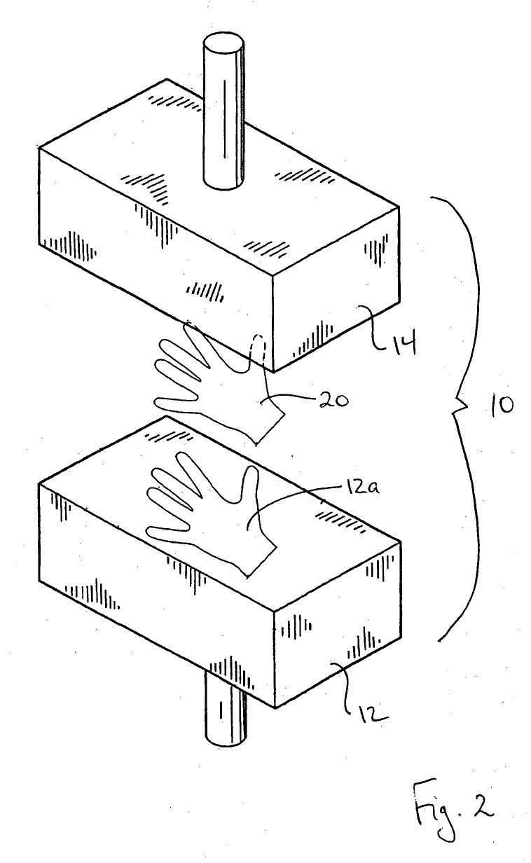

FIG. 1A shows a swatch 20 of the host material placed in a mold 10 prior to the molding step. In the example shown the swatch 20 is large enough to produce the front portion of a glove, but has not been cut to any particular shape. It is equally possible to cut the swatch 20 to the desired shape prior to the molding step, as shown in FIG. 2. The swatch 20 of host material is placed into the mold part 12, disposed over the mold cavity 12a.

A suitable moldable, flexible, slip-resistant material such as rubber, silicone rubber, PVC, TPR, or any other suitable material, is applied to the mold 10 in conventional fashion, for example by injection or by any other means. The mold part 14 is clamped to mold part 12, and heat and pressure are applied as required, depending upon the material selected for the slip-resistant surface 22, to mold one or more slip-resistant surfaces 22 onto the swatch 20 of host material to produce a composite material consisting of the slip-resistant surface permanently bonded to the host material. FIG. 1B illustrates the swatch 20 of composite material produced after the slip-resistant surface 22 has been applied in the molding step.

The swatch 20 of composite material is then removed from the mold 10, and preferably die cut or otherwise trimmed to the desired shape, as shown in FIG. 1C, resulting in a finished unitary glove part 24 ready for assembly into a glove. In an alternate embodiment in which the swatch 20 of host material is cut into a glove part prior to the molding step, the glove part 24 is ready for assembly into a glove immediately after the molding step.

The glove is constructed using the swatch of composite material, and preferably a second material for the remaining parts of the glove to reduce the cost and weight of the finished product. In the preferred embodiment the second material can be the host material, or it can be any other suitable material. The remaining parts of the glove can also be produced from a like composite material, although this would typically be done for aesthetic or protective purposes since slip-resistance is typically not required of parts of the glove other than the front portion.

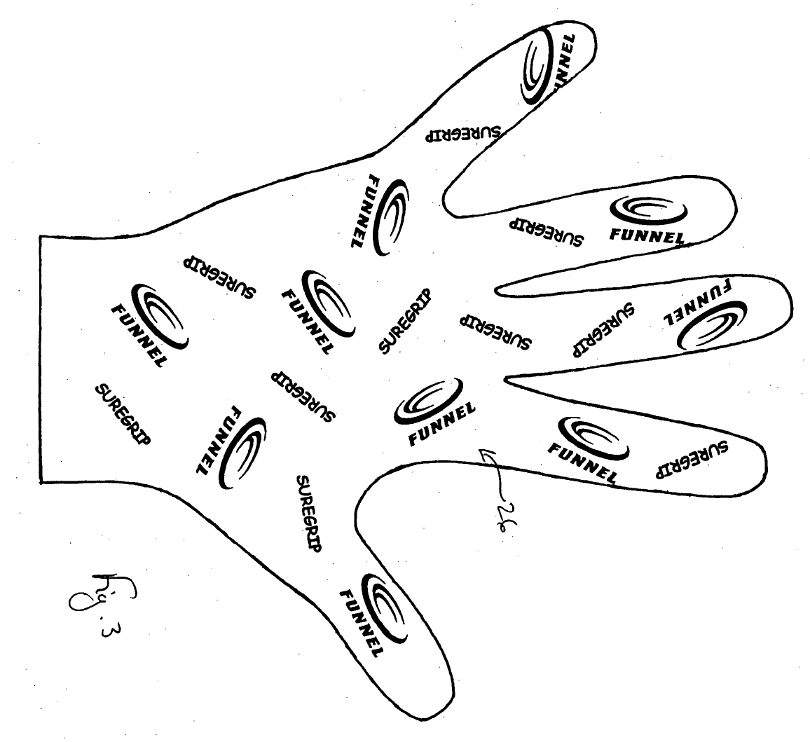

FIG. 3 illustrates a the front portion 26 for a glove, having a slip-resistant surface 22 comprising a print or screen applied to the swatch 20 of host material in the form of indicia, in the embodiment shown a brand name and logo. This embodiment can be employed for brand recognition or any other aesthetic or design function, for example a camouflage for hunting or a flower design for gardening gloves. The indicia is applied to the swatch 20 of host material, for example by screening or printing, decal etc., and a transparent slip-resistant material (for example clear rubber) is used in the molding process so that the indicia can be seen through the slip-resistant surface. The slip-resistant surface 22 thus both provides improved gripping ability and protects the indicia from wear through use and the elements.

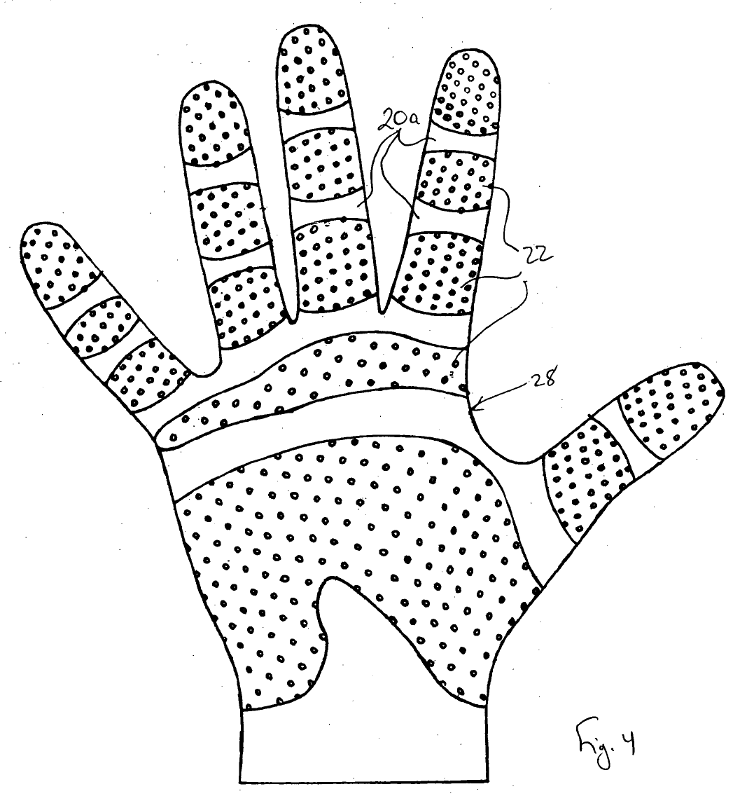

In the embodiment illustrated in FIG. 4, the composite material forming the glove portion 28 comprises a plurality of slip-resistant surfaces 22. The slip-resistant surfaces 22 are interposed with surfaces of the host material 20a, which are advantageously disposed in positions corresponding to joints of a user's hand. This allows for a thick protective and slip-resistant surface which does not significantly impede movement of the user's hand.

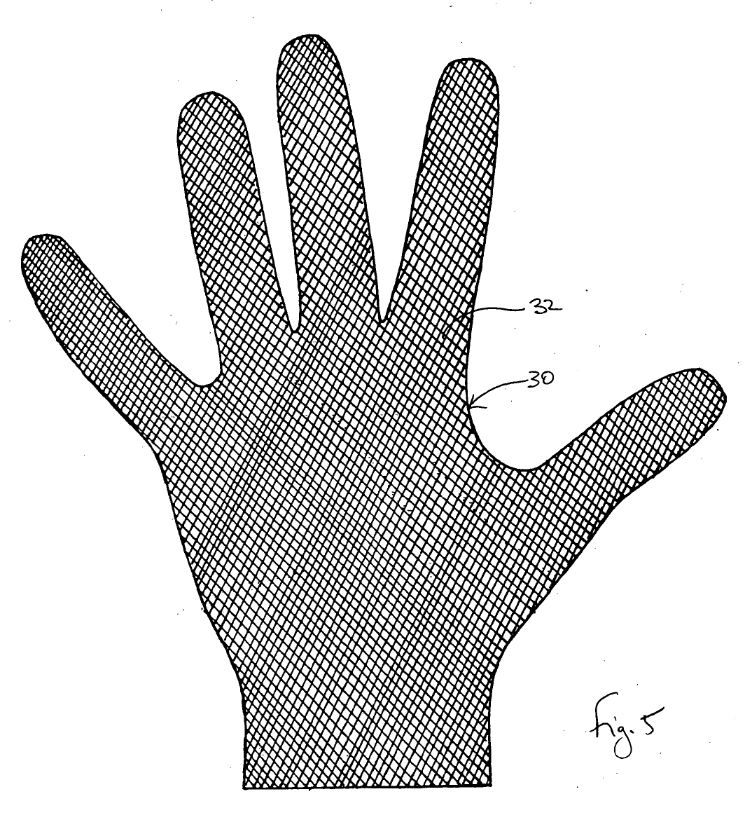

In the embodiment illustrated in FIG. 5 the glove portion 30 has a slip-resistant surface 22 comprising a texture 32, for example a knurled texture as shown. This improves the slip-resistance of the glove, and the design of the texture can be used to improve the aesthetic quality of the glove.

The invention can be applied to other types of coverings as well. For example, the method of the invention can be used to apply a slip-resistant surface to a tape or fabric strip, for example to be wound as a grip on sports equipment such as a tennis or badminton racket, baseball bat, golf club and the like.

Various embodiments of the present invention having been thus described in detail by way of example, it will be apparent to those skilled in the art that variations and modifications may be made without departing from the invention. The invention includes all such variations and modifications as fall within the scope of the appended claims.

I claim:

1. A method of applying a slip-resistant surface to a hand covering in a mold, comprising the steps of:
a. cutting a swatch of a host material into the shape of a hand covering,
b. placing the swatch of a host material in the mold,
c. applying a slip-resistant material to the mold,
d. applying heat and pressure to the slip-resistant material thereby bonding the slip-resistant material to the host material to produce a composite material, and
e. constructing a hand covering from the composite material, the composite material having the shape of a hand covering.

2. The method of claim 1 wherein the hand covering is constructed using the swatch of composite material and a second material.

3. The method of claim 2 in which the second material is the host material.

4. The method of claim 1 wherein the composite material comprises a plurality of slip-resistant surfaces.

5. The method of claim 4 wherein the composite material comprises a plurality of slip-resistant surfaces interposed with surfaces of the host material disposed in positions corresponding to joints of a user's hand.

6. The method of claim 1 wherein the slip-resistant surface comprises a texture.

7. The method of claim 1 comprising, before step a. or step b., applying a design to the host material, such that the slip-resistant material is applied over the design.

8. The method of claim 7 wherein the design comprises indicia.
